(19) United States
(12) Patent Application Publication
(10) Pub. No.: US 2009/0089401 A1
(43) Pub. Date: Apr. 2, 2009

(54) SERVER-CONTROLLED DISTRIBUTION OF MEDIA CONTENT

(75) Inventors: Geqiang Zhang, Redmond, WA (US); Vishal Sood, Bothell, WA (US); Christopher G. Knowlton, Redmond, WA (US); William J. Staples, Duvall, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/043,953

(22) Filed: Mar. 7, 2008

Related U.S. Application Data
(60) Provisional application No. 60/997,132, filed on Oct. 1, 2007.

(51) Int. Cl. G06F 15/16; G06F 15/173

(52) U.S. Cl. 709/218; 709/223; 709/228

(57) ABSTRACT

Described is a technology in which media content is sent to clients in partial pieces, so that a server may control how clients view (and/or hear) the media content. A client requests partial content, and the server allows or disallows the request based upon one or more various conditions, as evaluated against a playlist provided (e.g., by a playlist provider) for that client. For example, the playlist may specify that the client cannot skip content, whereby the server disallows a request for a piece of content that skips over other content. Session related data may be kept to track the content sent to the client. Media content may be sent based on a dynamic condition, and/or the playlist may be dynamically adapted. A piece of media content may comprise an advertisement, which may be custom-selected for that client, such as based upon user profile data and/or client location information.

### BACKGROUND

It is becoming increasingly popular for people to download media content from the Internet. Such content includes various types of pre-recorded video and audio files, as well as live programming, and includes both content that is free or paid for in some way, such as by subscription.

One problem is that when content is delivered through a web server, there is little or no control over how the user views and/or listens to the content. For example, a viewer may choose to skip over certain content, or seek within the content. As one consequence, this essentially means that there is no easy way to serve content that earns reasonable revenue from advertisements, as advertisers will not pay, or will pay relatively little, when there is no guarantee that a viewer will not just skip over their advertisements. No known standard and/or solution currently exist to control user interaction with served content.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a server controllably sends pieces of media content to a client in response to client requests. For each client request (or for a subset of the requests), the server determines whether the client is allowed to receive a particular piece of media content that corresponds to that request. If so, the server sends that particular piece of media content.

In one example implementation, the server creates a session for the client, and maintains session-related data corresponding to that session. For example, the session-related data may track the content previously sent to the client. The determination as to whether the client is allowed to receive a particular piece of media content may be made by evaluating a playlist associated with the client against the session-related data. A playlist provider may provide the playlist. The playlist provider may also be coupled to the server and to a media content source to provide the media content as content items in response to the client requests for media content.

In one aspect, media content may be sent to the client based on a dynamic condition, and/or a playlist may be dynamically adapted. Further, a particular piece of media content may comprise an advertisement. The advertisement may be selected (e.g., by the server or a playlist provider) from among a plurality of possible advertisements, such as based upon user profile information associated with the client, and/or based upon location information associated with the client.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a diagram representing an example flow of communications to provide controlled delivery of media content.

FIG. 2 is a diagram representing an alternative example flow of communications to provide controlled delivery of media content.

FIG. 3 is a block diagram representing components, including modules of an internet information service (IIS) server, that are involved in controlled delivery of media content.

FIG. 4 is a representation of example data flow including in components of in an internet information service server to provide controlled delivery of media content.

FIG. 5 is a diagram representing an example flow of communications to provide controlled media content delivery, including via an internet information service server.

FIG. 6 is a flow diagram generally representing example steps taken by a server to provide controlled media content delivery to a requesting client.

FIG. 7 is a flow diagram generally representing example steps taken by a server working in conjunction with a provider to provide controlled media content delivery to a requesting client, including in an adaptive manner.

FIG. 8 shows an illustrative example of a computing environment into which various aspects of the present invention may be incorporated.

### DETAILED DESCRIPTION

Various aspects of the technology described herein are generally directed towards facilitating the controlled delivery of web media content, including by progressive download from a web server. As will be understood, this provides the ability to exercise server control on media delivery. Among other aspects, this allows server-side control over operating functionality exposed to the client, such as seek, skip forward, skip backward and/or the like.

With sever control, content may be delivered in a way that is flexible with respect to various customer needs, yet is extensible for various business models and the like. For example, content may be served differently based on user-related and/or location-related considerations, such as to target advertisements to certain locations and/or types of users. Further, such control may prevent skipping or seeking, or may allow some interaction to an extent based on conditions, such as how much percentage of the total content has been sent to a client thus far; e.g., a client may be allowed to skip forward to the next content in the playlist after eighty percent of that piece of content was previously sent. Some operations may be allowed for certain clients and disallowed for others, such as allowing paid subscribers to skip over content but not allowing the same functionality to non-paying clients.

While various examples herein are primarily described with respect to interaction between a single client and a single web server that acts as an intermediary to selectively and controllably retrieve content from a content source, in which enforcement of server controls is accomplished via a client/user session, it is understood that these are only examples. For example, it is understood that the technology described herein is intended for use in a networking (e.g. Internet) environment that includes many clients coupled to possibly many servers, which in turn may receive content supplied by various content providers. Moreover, it is feasible for the server to contain the content, and indeed may cache content (e.g., popular content) and/or employ a local virtual-like content provider to avoid unnecessary communication with a remote content provider.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, networking and content delivery in general.

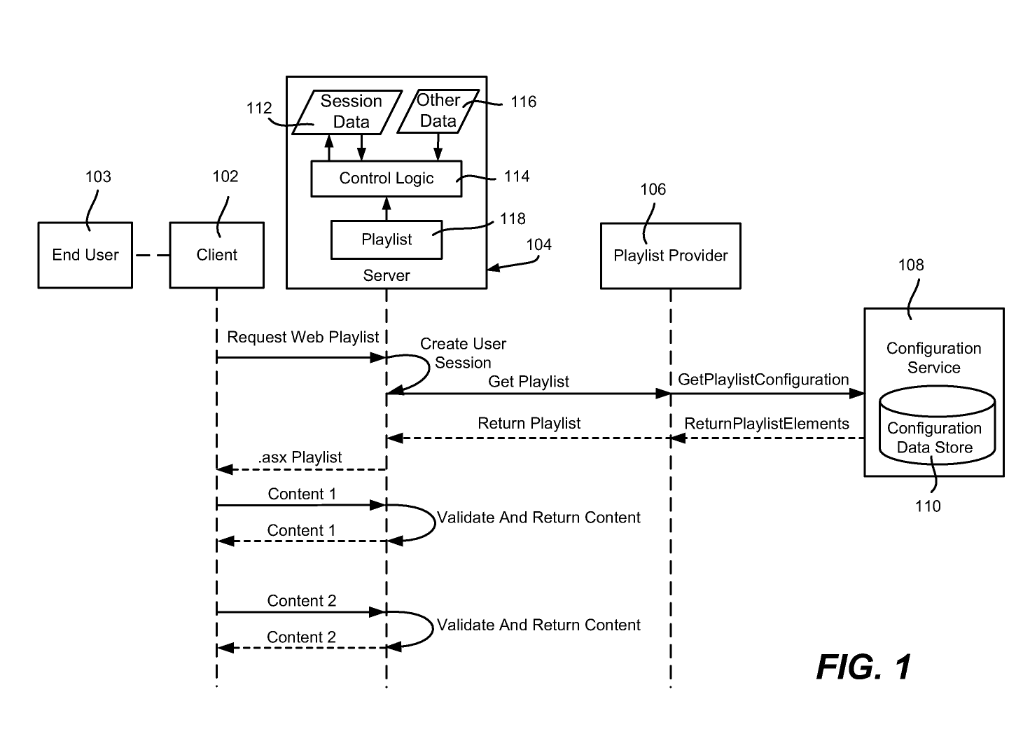

Turning to FIG. 1, there is shown a conceptual representation of a general operational flow of communications over time for obtaining and using a web playlist to control media content delivery, in which the order of operations generally progresses from top to bottom; (note that time is not intended to be linearly represented in FIG. 1, nor represented according to any other pattern). In general, a client 102 such as associated with an end user 103 clicks on a link or the like that takes the user client to a web playlist site provided by a server 104. In this example, the server 104 creates a session for the client 102, which may require credentials, payment and so forth.

In the example implementation of FIG. 1, the server 104 is coupled to a playlist provider 106 that is associated with a configuration service 108 having a data store 110 containing content corresponding to the playlist. The server requests a current playlist from the playlist provider 106, which in turn sends a request (e.g., GetPlaylistConfiguration) from the configuration service 108. In response, the service 108 returns data (e.g., ReturnPlaylistElements) corresponding to the current playlist, which the playlist provider 106 can process (e.g., format) as desired to return a playlist to the server 104. Note that these elements and/or the playlist may include any corresponding content that is needed (e.g., not already cached) by the server 104 and/or provider 106.

In return, the server 104 provides the client 102 with a client-side playlist (e.g., in the form of an .asx file that references one or more content files or the like) that has entries to some or all of the media content. The client may now select among the one or more entries in the playlist for playing the corresponding content. As generally represented in FIG. 1, the client thereafter requests partial content, in pieces (Content 1, Content 2 and so on), and receives corresponding content after the server validates the client session and the request that is made.

By way of example, a client may be requesting to skip forward by requesting a particular piece of content that is out-of-order with respect to another piece of content not yet sent to the client. Whether that request (a skip operation) is allowed is evaluated by the control logic 114 based on what the playlist states (if anything) about skipping over content. The playlist may include data specifying under what conditions a skip is allowed, such as if based on how many bits the user has been previously sent.

In the example of FIG. 1, server control is exercised through a user session that is created by the server on the first client request. The server 104 maintains session-related data 112, such as including a set of conditions that may be used by control logic 114 to validate the client and/or to evaluate other conditions associated with that client, such as to track the pieces of content (e.g., bits or groups of bits) downloaded by the user/client 102. Other data 116, such as time of day (or time of last content send operation) and/or client-specific data (e.g., user profile and/or current location, which may be dynamic in the case of a mobile user) may be evaluated by the control logic 114 against information in the playlist 118 to determine which operations the client is allowed to perform.

As represented in FIG. 1, with each subsequent user request for content, the server 104 revalidates the request against the session data to determine whether to allow any requested end-user operations, such as seek or skip, which are allowed only if the configuration (e.g., as set forth in the playlist 118) allows them. As described above, for this session the control logic keeps track of what content the user has received, whereby the server 104 can control operations like allowing skipping to the next content after a threshold percentage has been sent. This capability also facilitates the caching of the next piece of content, such as based on a certain percentage of previous pieces being delivered.

FIG. 1 also exemplifies the playlist provider 106. The provider 106 (which may be part of the server service as the server 104 or an independent entity) determines what content is deliverable as a part of the playlist 118, and therein also provides the server 104 with the information as to which operations are allowed (or disallowed) on a particular piece of content. Example operations include seek, skip forward or skip backward. The playlist provider 106 also may receive the user's profile and/or location data and use it to provide information from the server 104, which allows the playlist provider 106 to build a playlist most appropriate for the content and client. This provides flexibility to serve user-specific and/or location-specific content, along with the ability to be able to dynamically change the playlist based on a request.

By way of example, consider that content downloaded to certain users contains advertisements tailored to the user's profile and/or location, such as advertisements for local car dealerships that are generally close to a viewer's location. Not only may the advertisements be selectively chosen for that viewer/location, but the playlist may disallow skipping over such advertisements for free (e.g., non-premium paying) viewers. However, with a different playlist such as for other types of users, certain users such as premium subscribers may be allowed to seek and skip at will. Each of the users see the desired content, but different types of users are able to interact differently with the content (e.g., skip or not) each according to that user's respective playlist maintained at the server.

Moreover, because content is downloaded in pieces of partial content, the server remains in control, whereby for example the typical viewing process may be dynamically changed by the server (or possibly the provider 106) at any time. This allows the interruption of regular content viewing such as to play a commercial advertisement during an unpredictable break (e.g., a timeout during a sporting event), or to convey an emergency weather warning, and so forth. Via server control, content playback can also be regulated, e.g., a user may be prevented from receiving the same content again and again, such as to prevent playing the same song more than three times in an hour.

Multiple formats may be specified in the same playlist. A client 102 (e.g., manually by the user or by an automated process) may then choose the type of format for the content. For example, one client may want an .asx formatted playlist, while another client wants a differently-formatted playlist. Note that the playlist format is extensible, e.g., a particular implementation may use .asx as the format while others may use their own custom client-side playlist formats. Further, the playlist may contain items that are different format types, e.g., a single playlist could have .wma, .wmv, .mp3 and so on from which a user or process may choose.

To summarize, some of the various aspects and/or alternatives thus include delivering the content in multiple formats through a single playlist, and/or delivering the content using existing client-side playlist formats. The content may be user-specific and location-specific, and further may be delivered based on dynamic events. For example, a tornado warning may be overlaid or substituted for other content for users in a certain location, an unexpected disruption of a sporting event (e.g., rain delay) can covered by advertisements and/or prerecorded content, and so forth; tailored and/or dynamic control may apply to many different events and situations. Still other aspects include the ability to build an extensible solution for providing server-controlled media content delivery, which allows solutions to be easily customized through generic interfaces exposed by a base solution.

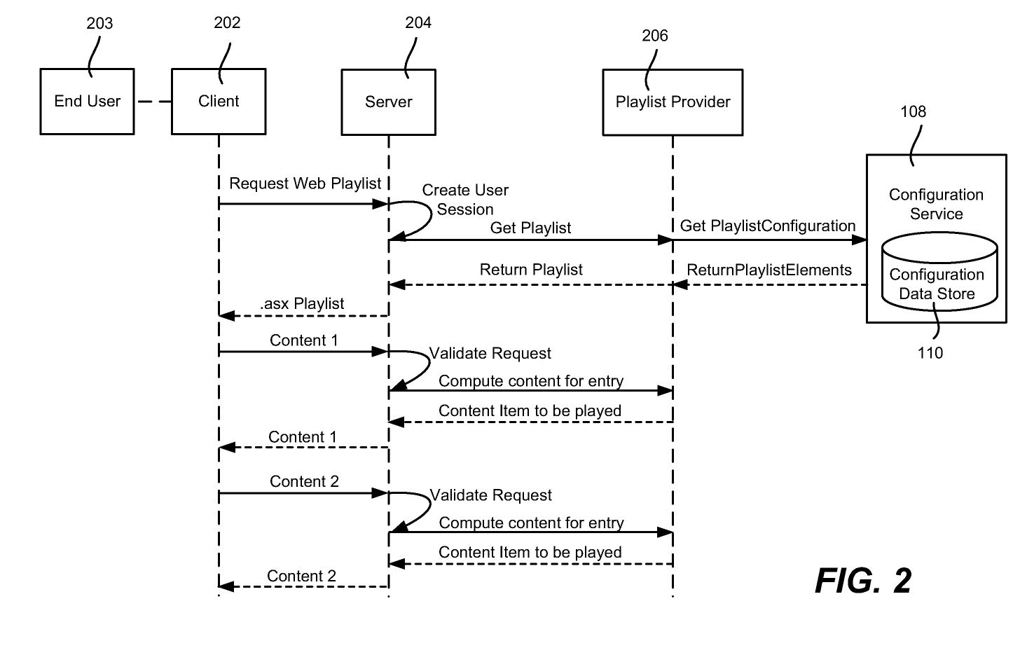

Another alternative variation is represented in FIG. 2, in which a server 204 queries a playlist provider 206 on every request, including requests for partial content items. As can be seen, FIG. 2 facilitates a flow of communications (calls) for an adaptive playlist, in which the playlist provider 206 and/or the server 204 have an opportunity to compute and/or control the flow of content to the client. Note that control logic and associated data (e.g., the playlist and session data) similar to that shown in FIG. 1 may be implemented in the server 204 or the provider 206, or partially in the server 204 and partially in the provider 206. As in FIG. 1, the server 204 and playlist provider 206 may be considered a combined service, or may be separate entities that together appear to act as a service from the perspective of clients. The actual content item delivered for any entry in the playlist may thus be changed by the playlist provider 206, providing for significant flexibility. This flexibility is extremely useful in building adaptive systems and/or changing content on user actions. For example, not only may advertisements be selected based on each particular client's demographic profile and/or current location, but game environments or other content may be changed depending on user actions, a user may interact with content during a television or movie to make a purchase (e.g., order food delivery), and so on.

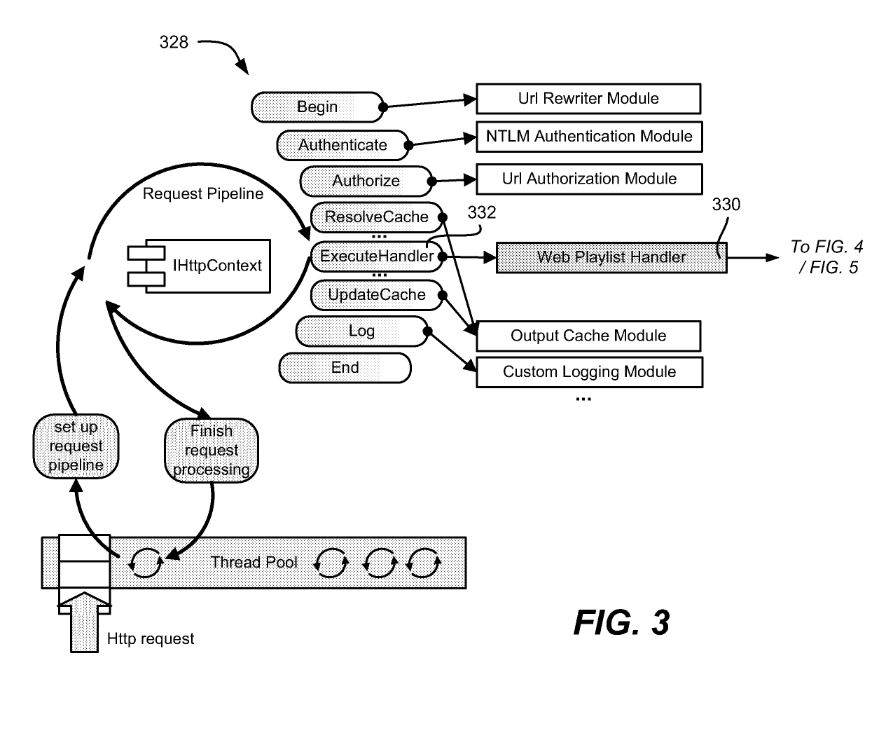

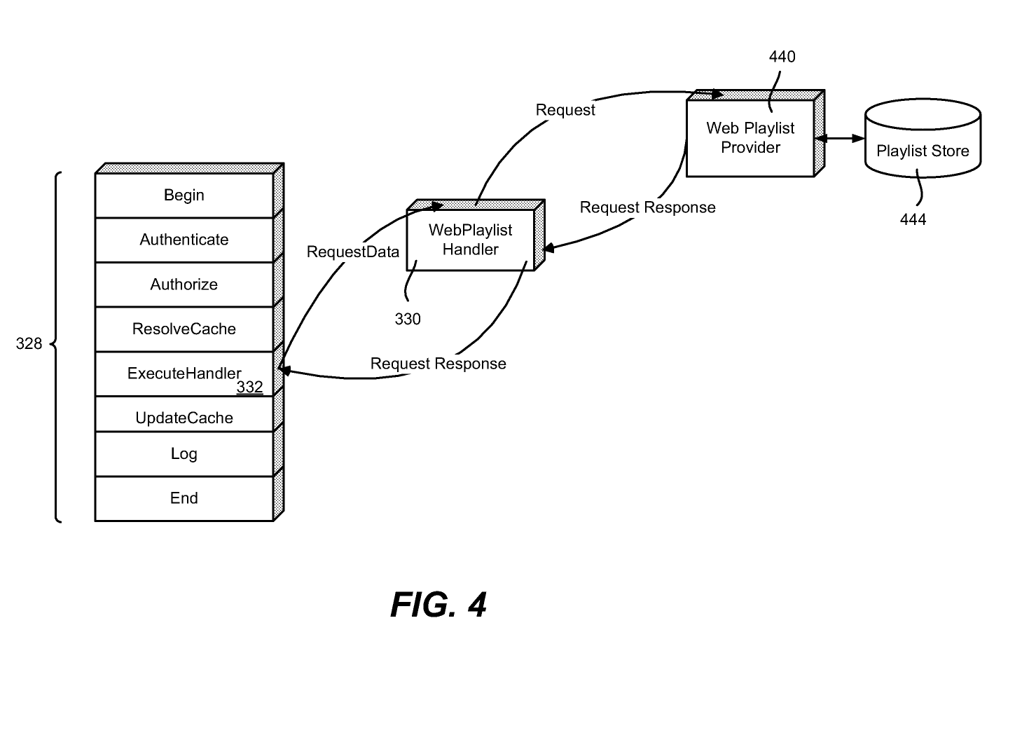

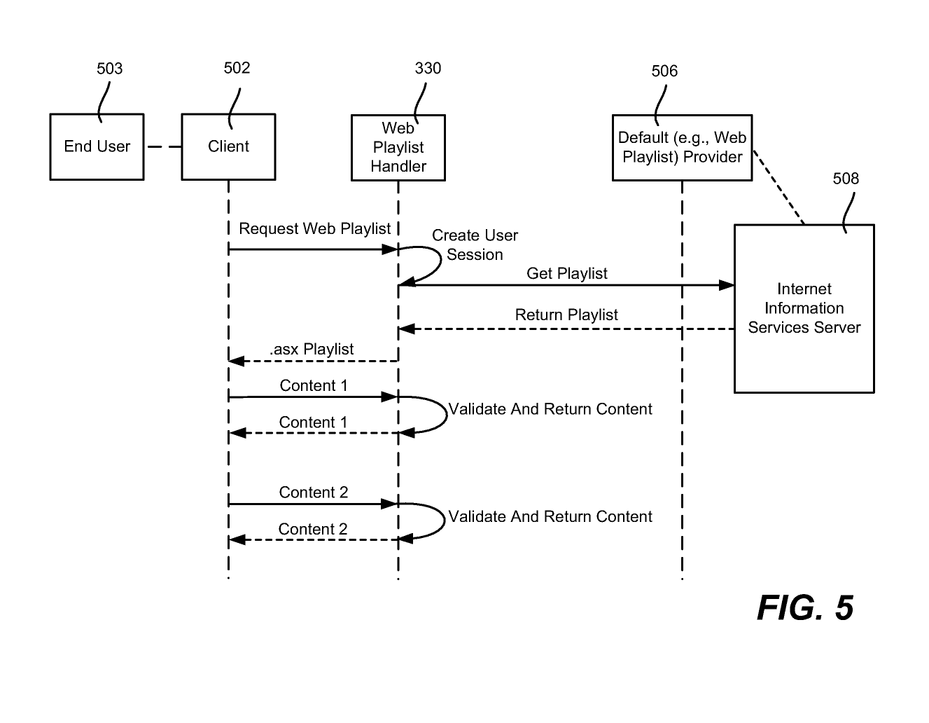

In one example implementation, namely an Internet Information Server (IIS) implementation generally represented in FIGS. 3-5, the above aspects were provided in a web playlist solution for an IIS web server platform. In the particular example implementation, this feature was implemented using an IIS 7 integrated pipeline 328, however it is understood that this was only one of several alternative implementations that may have been used to provide similar or identical results. Note that blocks 502 and 503 in FIG. 5 correspond to the client and end-user of FIG. 1. However, the server aspects are implemented in a web playlist handler (module) 330 described below, which works with a default provider 506 (e.g., corresponding to the web playlist provider 440 of FIG. 4) and internet information services server 508 to obtain the playlist and any needed content.

FIGS. 3 and 4 generally demonstrate an example of such an IIS7 pipeline 328, coupled to a web playlist handler 330, which in turn is coupled to a WebPlaylist provider 440 (FIG. 4). A web playlist is implemented as a request handler in the IIS Integrated pipeline. IIS7 calls an execute handler 332 (ExecuteHandler) for the web playlist, and passes the execute handler 332 the request data (e.g., a URL plus User Session data). The execute handler 332 may be written in a native code module in IIS.

FIG. 4 is generally directed towards the aspect of Web Playlist integration with the example IIS7 mechanism; note that an unmanaged handler may be used so that it is supported on the server core. In FIG. 4, the execute handler 332 is represented as a block in the pipeline 328, in which a Web Playlist handler mapping specifies a module that attempts to provide request handling services during the ExecuteRequestHandler pipeline stage. In this system, the web playlist handler 330 registers for notifications, (as do other IIS modules), whereby the IIS server deliver notifications to the handler based on the handler mapping. Note that in one example implementation, the web playlist handler 330 returns HANDLED during the ExecuteRequestHandler notification if it chooses to handle the request. If not, it is expected to return CONTINUE so that the next module in line will attempt to handle it.

With respect to a user session, the handler 330 starts and maintains a user session for client requests. As described above, the user session is used to keep track of data such as bytes downloaded, to enforce the playlist attributes. Note that one example feature implements a server-side playlist through a client-side playlist. In this implementation, there is a chance that the player may not respect the playlist attributes, or that the client-side playlist may be edited.

In one example implementation, the handler 330 creates a GUID or the like as a session identifier as soon as it gets a request. The user session is identified through this GUID, which passed during the communications. The response to the request comprises a client-side playlist, e.g., passed as a bit stream. This client-side playlist may contain obfuscated entries that have these GUIDs as a part of each media entry URL. Note that protection mechanisms may be provided for user sessions, such as to protect the content from being linked to an unauthorized source. For example, if a user watches a playlist containing an advertisement and a movie clip, the user may otherwise intercept the movie clip URL, and post it to a blog/forum. To protect the content from such an unauthorized link, the server can make sure there is only a limited amount of concurrent connections (e.g. two, one for current play and one for pre-rolling a next entry) for one user session, and/or have a timeout mechanism so that the user session is terminated after some time of inactivity. Further, if the user session data (such as the GUID in the URL) is tampered with in any way, the server may fail the request, in order to protect the content.

Other aspects related to giving the media content owner better protection include that the media content or contents that are referenced by the playlist do not need to be located in the published web server URL namespace. In such a situation, it is not possible for the client to directly access the media content by static file URLs (such as http://server/abc123.wmv); instead, the only way to get to content is via the playlist handler, including following the rules defined by the playlist. On the server side, the content can reside in locations that require special user credentials, whereby a server administrator may configure access options so that only a web playlist or the like may have access to that location.

A server-controlled playlist also prevents unauthorized links to the content in the playlist. With a server-controlled playlist, (in contrast to a traditional playlist in which users can directly share the links to one piece of content of a playlist and ignore other controls), it is not possible to directly share the playlist content URLs among clients because of enforcement mechanisms, such as the concurrent client connection limit and session timeout set forth above.

Still further, the client-side cache may be disabled when serving content from the playlist so that ordinary clients are unable to play the same content from a local cache. With such a mechanism, clients have to request the desired content from the server each time. Note that this only provides partial protection with ordinary users, as it is possible to modify clients to cache the content. However, digital rights management (DRM) technology can be used in conjunction with web playlist for more comprehensive content protection.

As mentioned above, FIG. 5 shows an example communications call flow for the example IIS implementation/web playlist provider. Note that there may be support for both unmanaged and managed provider support. For example, a default provider 506 may be included “shipped out of the box” to provide support for XML playlist syntax and also have integration with Windows® users and groups. The default provider 506 may be unmanaged so as to work on Server Core installations. The default web playlist provider 506 may store playlists in a suitable (e.g., XML-based) format in the backend.

With respect to a playlist store 444 (FIG. 4), one suitable database for the default provider 506 includes .config files. Example sizes for a playlist are currently on the order of 100 KB to 250 KB.

Note that the default provider 506 may achieve some of the above-described scenarios using a declarative syntax. For example, configuration sections may be written that allow for patterns. These patterns may be then matched to tags on the media content to retrieve the correct media content based on user or location attributes.

Turning to extensibility, it can be readily appreciated that custom providers may extend the playlist support. This may be of considerable value, such as in situations that provide user-specific and/or location-specific content through the use of cookies, URL modifiers, IP addresses, user profile attributes, group attributes, roles, and so forth. The custom providers may be written in managed or unmanaged code. However writing managed code is typically faster and easier, whereby having managed custom providers improves the chances of community involvement.

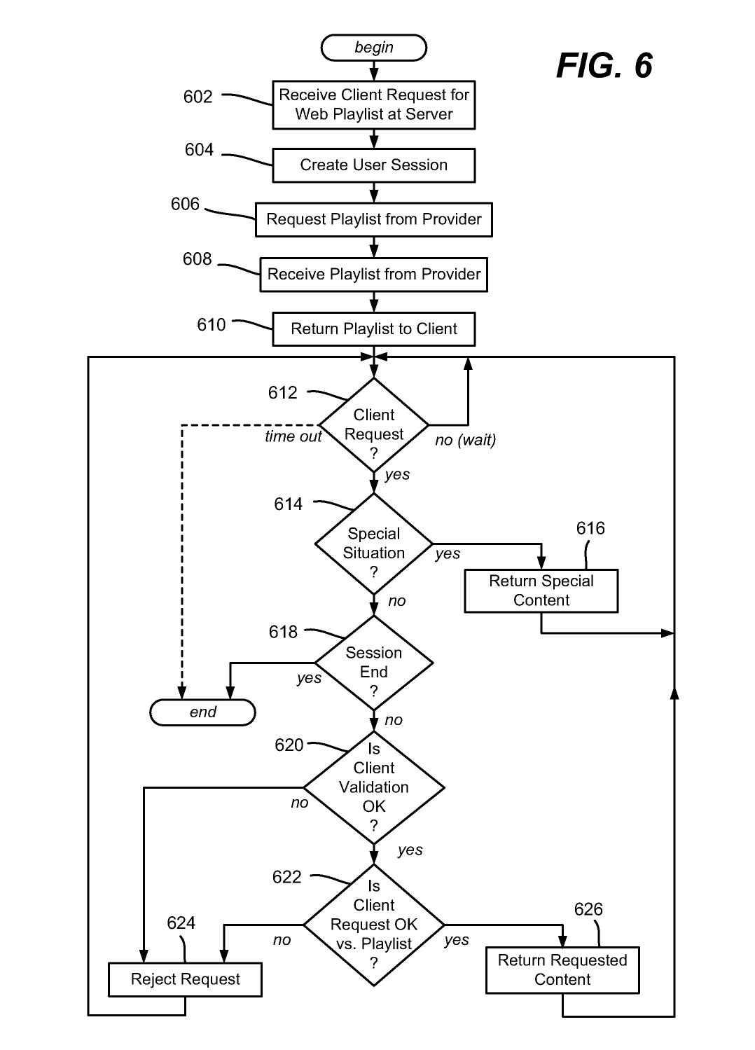

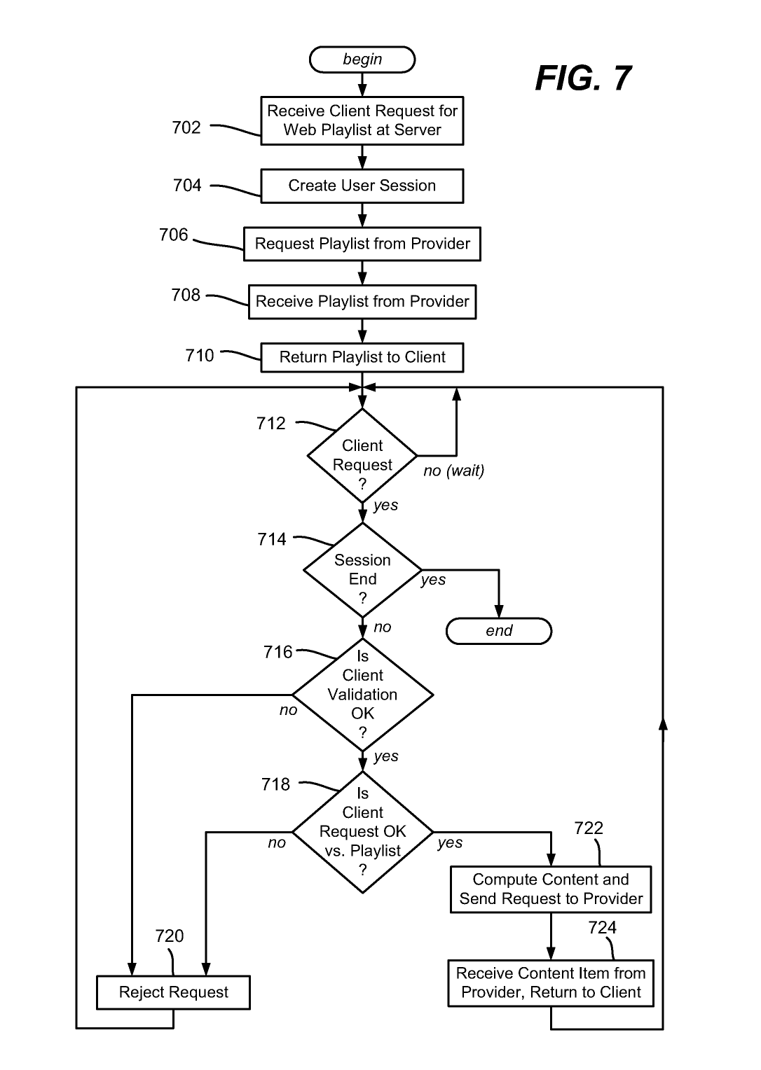

By way of summary, FIG. 6 is a flow diagram from the perspective of an exemplified server corresponding to the examples of FIGS. 1 and 5, e.g., where the server validates and returns client requests for content. FIG. 7 is a flow diagram from the perspective of an exemplified server and provider corresponding to the example of FIG. 2, e.g., where the provider is involved in returning requested (or other) content.

In FIG. 6, beginning at step 602, the server receives a client request for a web playlist. The server then creates a user session (step 604), requests a playlist from the provider (step 606), receives a playlist in response (step 608), and returns the playlist to the client (step 610). As represented by step 612, the server then waits for a further client request. Note that as indicated by the dashed line branching from step 612, the server can time out and end the session if the client does not return a suitable request within a given time.

When a client request is received as detected by step 612, further processing continues. In this example, at step 614 the server first considers whether there is a special situation of which the server is aware (at least with respect to this particular client) that takes precedence over a client content request, such as an emergency warning that is returned regardless of the client request. If so, step 616 returns corresponding special content. Note that in one alternative, step 614 may be within the wait loop (e.g., before step 612) so as to push special content such as an emergency warning to a client independent of a client request, although the client may need to be configured to accept such pushed content. In another alternative, the server may superimpose or insert graphics or the like over or adjacent another piece of video content (e.g., to be returned at step 626), and thus provide special content without interrupting the main or other video content.

If there is no special situation, step 618 evaluates whether the client request corresponds to ending the session. For example, the client may explicitly log out, such as if after reviewing the playlist no content is desired, or may indicate that no more content is desired, such as following a free preview and deciding not to purchase. Note that while step 618 exemplifies a session end, an additional alternative is to provide a mechanism for a client to select different content from the playlist or request a new playlist without ending the session.

When the client has requested content and the “no” branch of step 618 is followed, step 620 represents validating the client request, such as the GUID or other credentials that indicate the client is authorized to make the request; if not, the request is rejected (step 624). If validated, step 622 considers the requested content versus the playlist. For example, the playlist may indicate that this particular client, such as one that is viewing a program for free in exchange for having to view advertisements, cannot skip forward and is instead required to receive the content completely and in order (as opposed to a premium-level client, for example). If in such an example the client request is directed towards receiving content on the playlist that is ahead of the proper order, the request is rejected (step 624). Note that even when a client is not allowed to skip ahead, the playlist may contain entries for different portions of content within a single program, so that a client can skip backward to an earlier portion, for example, or skip forward within already received content.

FIG. 7 is somewhat similar to FIG. 6, although it will be seen that in these example steps, the provider is involved in providing items of content (as in FIG. 2). Note that in this example, steps 702 through 712 correspond to steps 602 through 612 of FIG. 6, and step 714 corresponds to step 618, and thus those steps are not again described for purposes of brevity. Further note that although not shown in FIG. 7, a server can substitute its own content if needed, such as in a special situation as in step 614 of FIG. 6, but in this example the provider also has such ability.

If at step 716 the client is validated and at step 718 the client request is allowed according to the playlist, at step 722 the server computes a request for corresponding content, and communicates the request to the provider. Otherwise the server may reject the request (step 720). The server receives whatever item of content the provider returns, and forwards that item onto the client. As can be readily appreciated, the computation at step 722, and/or the provider's ability to selectively return content items enables an adaptive system.

As can be seen, there is described herein the controlled delivery of media content from the web in various, flexible ways. Scenarios including monetization and/or compliance are enabled through the use of controlled media content delivery as described herein.

### Exemplary Operating Environment

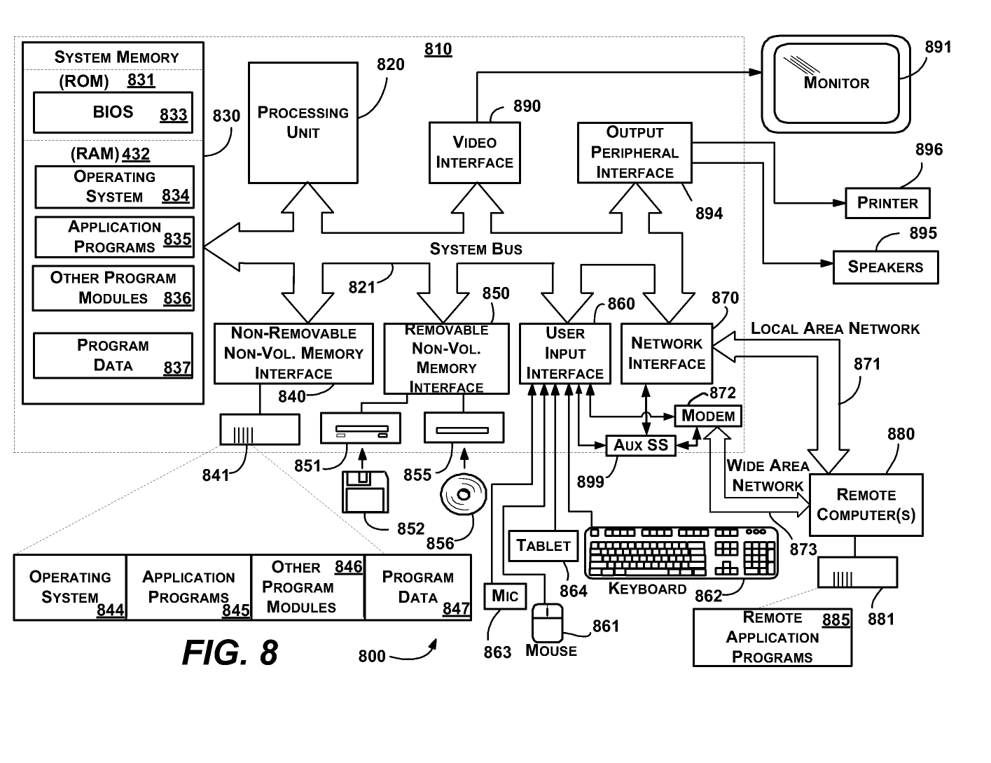

FIG. 8 illustrates an example of a suitable computing and networking environment 800 on which the examples of FIGS. 1-7 may be implemented; (for example, the server and/or provider may be implemented in a computer 810, with clients comprising remote computers 880, or vice-versa). The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 8, an exemplary system for implementing various aspects of the invention may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media can be any available media that can be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 810. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, application programs 845, other program modules 846 and program data 847. Note that these components can either be the same as or different from operating system 834, application programs 835, other program modules 836, and program data 837. Operating system 844, application programs 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel can be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component 874 such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communications link between the computers may be used.

An auxiliary subsystem 899 (e.g., for auxiliary display of content) may be connected via the user interface 860 to allow data such as program content, system status and event notifications to be provided to the user, even if the main portions of the computer system are in a low power state. The auxiliary subsystem 899 may be connected to the modem 872 and/or network interface 870 to allow communication between these systems while the main processing unit 820 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a networking environment, a method, comprising:
receiving requests for pieces of media content from a network client; and
controllably sending pieces of media content to the client in response to the requests, including, for at least one of the requests, determining whether the client is allowed to receive a particular piece of media content that corresponds to that request, and if so, sending that particular piece of media content.

2. The method of claim 1 further comprising, creating a session for the network client, and maintaining session-related data corresponding to that session.

3. The method of claim 1 wherein determining whether the client is allowed to receive the particular piece of media content includes validating the client request for the particular media content.

4. The method of claim 1 wherein determining whether the client is allowed to receive the particular piece of media content includes tracking at least one other piece of media content sent to the client.

5. The method of claim 1 wherein determining whether the client is allowed to receive the particular piece of media content includes evaluating a playlist associated with the client.

6. The method of claim 1 further comprising, sending media content to the client based on a dynamic condition.

7. The method of claim 1 further comprising wherein the client is determined to be allowed to receive a particular piece of media content, wherein the particular piece of media content comprises an advertisement of a plurality of advertisements, and further comprises, selecting the advertisement from among the plurality of advertisements based upon user profile information associated with the client, or based upon location information associated with the client, or based upon a combination of user profile information and location information associated with the client.

8. In a computer networking environment, a method, comprising, controlling sending of media content by a client, including by selectively communicating partial media content to the client in response to a client request for media content, and processing additional client requests for other media content based upon tracking media content that has been previously communicated to the client.

9. The method of claim 8 wherein processing the additional client requests for other media content comprises maintaining session data indicative of what media content has been previously communicated to the client during a session, and evaluating information in a playlist associated with the client to determine whether other partial media content corresponding to one of the additional requests for media content is allowed to be communicated in response to that request.

10. The method of claim 9 further comprising dynamically adapting the playlist.

11. The method of claim 8 wherein selectively communicating the partial media content to the client in response to the client request comprises selecting content based upon a dynamic condition.

12. The method of claim 8 wherein selectively communicating the partial media content to the client comprises communicating with a media content provider to receive a media content item, and returning that media content item in response to the client request for media content.

13. The method of claim 8 wherein controlling the sending of media content comprises providing media content based at least in part on client location data or client profile data, or on both client location data and client profile data.

14. In a computing environment, a system comprising, a server that establishes a session with respect to communicating media content to a client, the server coupled to control logic that evaluates a client request for partial media content against data associated with the client to determine whether the request is allowed or disallowed.

15. The system of claim 14 wherein the control logic is incorporated into a service comprising the server, or comprising a playlist provider, or comprising the server and the playlist provider.

16. The system of claim 14 further comprising a playlist provider coupled to the server, and wherein the data associated with the client includes a playlist provided by the playlist provider.

17. The system of claim 16 further comprising a source of media content coupled to the playlist provider.

18. The system of claim 14 wherein the data associated with the client includes session data that tracks information with respect to the session, and wherein the control logic evaluates at least some of the session data against a playlist in determining whether an additional request is allowed.

19. The system of claim 14 wherein at least one of the additional pieces of content comprises an advertisement.

20. The system of claim 19 further comprising means for selecting the advertisement from among the plurality of advertisements based upon user profile information associated with the client, or based upon location information associated with the client, or based upon a combination of user profile information and location information associated with the client.
